(19) United States
(12) Patent Application Publication
(10) Pub. No.: US 2008/0298556 A1
(43) Pub. Date: Dec. 4, 2008

(54) HEARING AID-COMPATIBLE CORDLESS TELEPHONE WITH CORDED HANDSET

(76) Inventor: Andrew Valier-Grossman, Moshav Achituv (IL)

Correspondence Address: LADAS & PARRY LLP, 224 SOUTH MICHIGAN AVENUE, SUITE 1600, CHICAGO, IL, 60604, US

(21) Appl. No.: 11/754,731

(22) Filed: May 29, 2007

(51) Int. Cl. H04M 11/00

(52) U.S. Cl. 379/52

(57) ABSTRACT

A cordless telephone for use with a hearing aid includes an induction coil in a handset. The handset is electrically and mechanically connected to a platform or base for the handset such that the handset platform and handset are not farther from each other than the length of the cord that connects them. Audio processing circuitry in the remote station of the cordless telephone enables both volume control and tone control of the signals produced at the handset earpiece and induced by the hearing-aid compatible voice coil with the handset.

### BACKGROUND

Cordless telephones are well known and have been in use since before cellular technology was invented. They are simply described as a battery-powered portable handset that communicates over a full-duplex radio channel with an A.C. line-powered base station or base unit. The base unit provides an electrical and physical interface to the public switched telephone network. Telephone calls can be placed from, and received at, the portable handset so long as the handset and the base station remain within radio communication range of each other.

### SUMMARY

There is provided a cordless telephone comprised of a “remote station” and a base station. The base station provides an interface to a telephone network, such as the public switched telephone network, commonly abbreviated as the PSTN. Unlike prior art cordless telephones, the “remote station” is comprised of a handset that is hard-wired to a “handset platform.” The remote station thus resembles well-known prior art telephones, such as the one depicted in FIG. 1, except that the remote station has a handset that is hardwired to a resting platform. More importantly, the handset includes a hearing-aid compatible induction coil, which inductively couples audio signals from hand set to a user's hearing aid that is proximate to the induction coil in the handset. Locating the radio electronics in the phone's platform and away from the handset, which a user places next to a hearing aid, reduces or eliminates radio frequency interference to a user's hearing aid that would otherwise be caused if the radio electronics were in the handset. Volume controls and audio tone controls at the remote station also allow the audio level and tone quality to be adjusted to suit a user's preferences.

### BRIEF DESCRIPTION OF THE FIGURES

FIG. 1 depicts a cordless telephone with a corded “handset;”

FIG. 2 is a block diagram of electronic devices within the remote station of the telephone depicted in FIG. 1;

FIG. 3 shows the placement of the hearing aid compatible induction coil inside the handset; and

FIG. 4 is a schematic diagram of the output amplifier stage of the receiver portion of the remote station depicted in FIG. 1.

### DETAILED DESCRIPTION

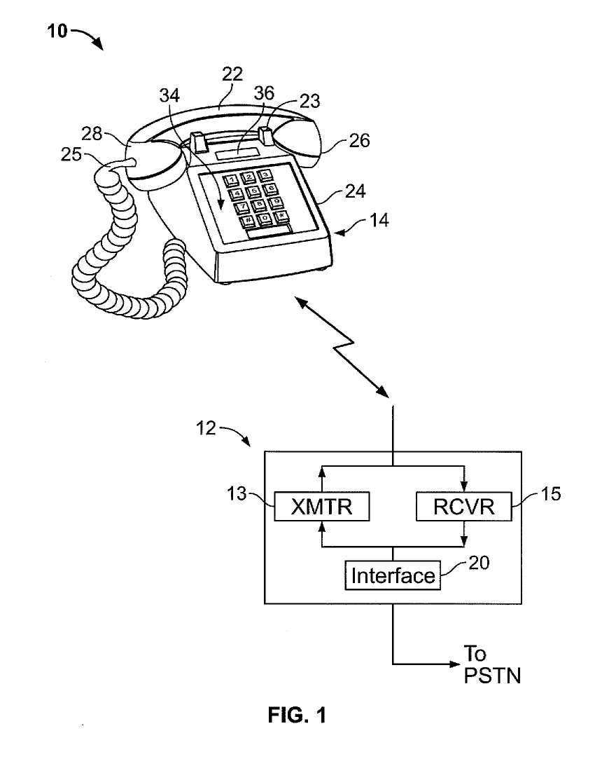

FIG. 1 depicts a cordless telephone 10, which is comprised of a base station 12 and a remote station 14. Unlike prior art cordless telephones, the cordless telephone 10 depicted in the figure has a remote unit 14 with a handset 22 that is connected to a handset platform 24 by a cord 25 such that the handset 22 is permanently connected to the handset platform 24.

Similar to prior art cordless telephones, the base station 12 has a radio transmitter 13 and a radio receiver 15, which cooperate with a radio transmitter and receiver (not shown in FIG. 1) within the remote station 14 to provide full-duplex wireless communications between the base station 12 and the remote station 14. The base station 12 is coupled to a telephone network, such as the public switched telephone network (PSTN), through interface circuitry 20, which is not shown in FIG. 1 for brevity, but well known to those of ordinary skill in the telephone art.

In various alternate embodiments, the base station 12 is provided with electronic circuitry (not shown for clarity) to provide the functionality of an answering machine. Incoming calls not answered after a user-specified number of rings, are “answered” by the answering machine electronics. A pre-recorded message is played to a caller by the answering machine electronics, after which a relatively short-duration message is recorded by the electronics within the base station 12 for later playback by a user.

The telephone network interface 20 allows the cordless telephone 10 to connect to and communicate signals to and from a telephone network. The interface 20 therefore handles signaling between the cordless telephone 10 and a telephone network. The interface 20 thus allows the cordless telephone to connect to, and work with, a conventional telephone network.

The handset 22 has both an earpiece 26 and a mouthpiece 28. As with prior art telephones, a user holds the handset 22 of the remote station 14 so that the earpiece 26 is next to his or her ear and the mouthpiece 28 is in front of the user's mouth.

The handset platform 24 has a cradle 23, where the handset 22 is kept when it is not in use. The platform 24 also has a keypad 34 and a display screen 36.

The keypad 34 provides the functionality of prior art keypads, e.g., “dialing” telephone numbers and for activating/controlling various calling features. Actuation of the keys of the keypad 34 causes the base station 12 to transmit the dual tone multi-frequency (DTMF) signaling tones to a switching network. In one embodiment, the DTMF tones are also audible to a user by their being generated within the remote station 14 using well-known, dedicated DTMF generator integrated circuits, not shown in the figures for clarity but well-known to those of ordinary skill in the telecommunications art.

The display 36 provides a display or rendering of information to a user. The display 36 can be embodied as either a liquid crystal display (LCD) device, LEDs or other, low-power consumption display device.

The remote station 14 of course includes a second radio receiver and a second radio transmitter, which are not shown in FIG. 1. The second radio receiver 30 and the second radio transmitter 32 within the remote station 14 are configured to operate on radio frequencies such that full-duplex radio communications can be established between the radio transmitter 13 in the base station 12 and the radio receiver 15 in the base station 12. The radio transmitters and receivers in the base station 12 and the remote station 14 thus provide a wireless, i.e., cordless telephone functionality to a user of the cordless telephone 10 but with remote station's handset being provided with an induction coil that is kept away from RF-emitting radio circuits.

The radio transmitters and receivers in the base station 12 and the remote station 14 are preferably of a type and/or design to frustrate both the unintended interception of signals between the base station 12 and the remote station 14 as well as intentional eavesdropping. Information content sent between the base station 12 and the remote station 14 can be digitized and encrypted using prior art techniques well-known to those of ordinary skill in the art. Signals between the base station 12 and the remote station 14 can also be modulated using various modulation techniques that make interception or eavesdropping more difficult. Spread spectrum modulation or frequency hopping are but two ways to transmit information between the base station 12 and the remote station 14 that would make eavesdropping more difficult unintended interception less likely.

In one embodiment, the remote station 14 has its radio receiver 30 and its transmitter 32 mounted in the handset platform 24. Locating the receiver 30 and transmitter 32 in the handset platform 24 reduces the handset 24 weight, but more importantly, it reduces or even eliminates radio frequency interference (RFI) to a user's hearing aid or other electronic equipment that might be worn around or near a user's head.

As can be seen in FIG. 1, the handset 22 and handset platform 24 are connected to each other through one or more wires in a cord 25 that run between them. The length of the cord 25 determines a distance by which the handset 22 can be spaced away or separated from the handset platform 24. The handset 22 and the handset platform 24 are therefore considered to be “hardwired” to each other in that they are electrically and mechanically connected to each other via the wires or cord 25 so that they cannot become separated from each other. When the handset 22 is not in use, it rests in the cradle 23, which also causes a switch hook in the platform 24 (not shown) to be activated in order to shut off much of the electronics in the remote station 14 as possible yet retain its ability to receive calls from the base station 12. By way of example, placing the handset 22 in the cradle 23 causes the transmitter 32 and audio circuits 48, 49 and 50 as well as keypad circuitry 34 to be powered off.

Connecting the handset 22 and the handset platform 24 by a cord 25 makes the cordless telephone 10 look and feel like a standard or conventional telephone. It also makes the cordless telephone 10 less likely to be lost or mislaid. Unlike prior art cordless telephones, and as set forth below, inclusion of an inductive coupling coil (not shown) in the handset 22 makes the cordless telephone 10 useful to individuals who use hearing aids with inductive pick-up coils. Separating the induction coil from RF-emitting circuits by locating them in the platform 24 minimizes or eliminates RF interference to a user's hearing aid.

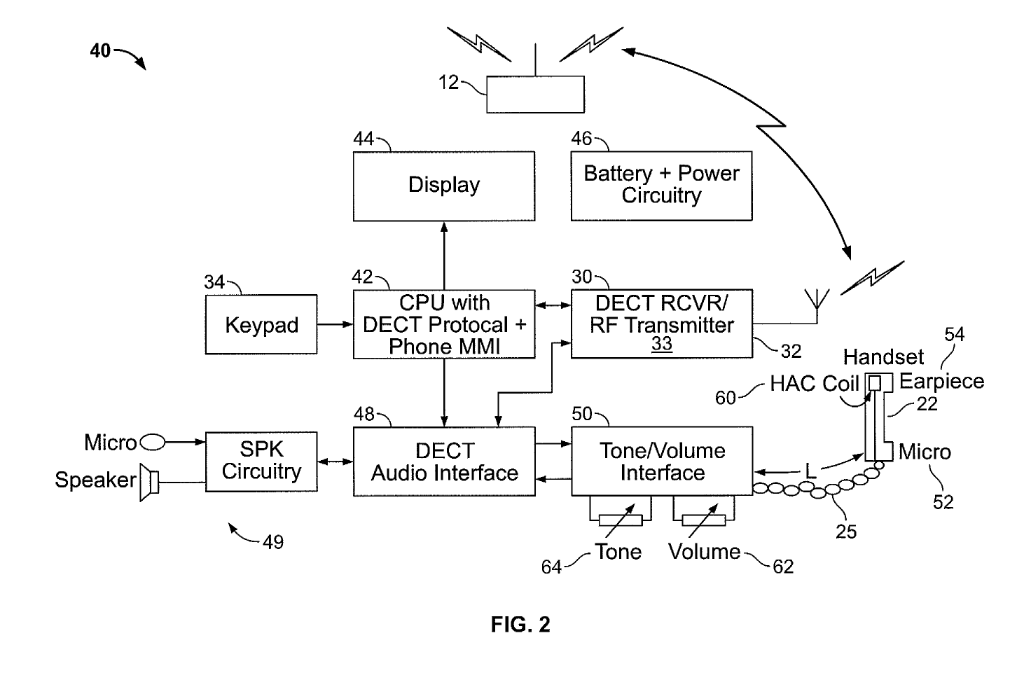

FIG. 2 shows a block diagram 40 of the remote station's electronic circuitry. The heart of the remote station is a microcontroller 42, which includes a CPU and on-board memory where program instructions and data can be stored. The on-board memory can be embodied as ROM, EEPROM, EPROM, flash memory and RAM. For the cordless telephone 10, the microcontroller 42 shown in FIG. 2 includes memory as part of the microcontroller 42 wherein computer program instructions are stored, which when they are executed by the CPU, they imbue the remote station with the functionality required to operate the various peripheral circuits shown in FIG. 2. Instead of using a microcontroller, alternate embodiments of the remote station 12 use a microprocessor and separate memory devices, programmable logic arrays (PLAs), as well as discrete combinational and sequential logic devices.

The display 44 device is a screen (either dot matrix panel or LCD) to display information that includes but not limited to phone status and/or a menu of telephone settings. In the embodiment shown in FIG. 1, the display 44 is located on the handset plat form 24, however, alternate embodiments locate the display 44 on the handset itself. In one embodiment, the display 44 is provided with a backlight to help user to read information and to enable the cordless telephone 20 to be used in dark environments.

The battery and power circuitry 46 is embodied as either one or more batteries or an A.C. power source. Different voltages are obtained from the respective sources to power circuitry in both the remote station handset 22 and the remote station handset platform 24. The power source 46 can be located in either the handset 22 or the handset platform 24, however, locating the power source 46 in the handset platform 24 instead of the handset 22 will reduce the handset 22 weight making the handset easier to handle. In one embodiment, an A.C. power source re-charges rechargeable batteries.

The keypad 34 is coupled to an input port of the microcomputer 42. The keypad 34 provides at least twelve keys that are separately addressable by the microcontroller 42. The microcontroller 42 scans the keys to detect when they are actuated. A key actuation causes the microcontroller to instruct the transmitter of the remote station, to send a corresponding signal to the base station 12 to indicate that a digit was dialed. If the actuated key is one of the twelve standard keys of a telephone keypad, the microcomputer 12, or a dedicated DTMF tone generator integrated circuit, generate corresponding DTMF tones and can also enunciate the tones to the telephone user through the earpiece 54. The keypad 34 keys also provide other special functions or special features that may be provided to the remote station 14, such as memory dialing, ringer control, backlight control etc. The keys of the keypad are also used to access the telephone's menu and setting options.

The remote station shown in the figures locates the keypad 34 on the handset platform 24. Alternate embodiments locate the keypad 34 on the handset itself, with and without the display being co-located on the handset.

The receiver 30 of the remote station 14 is comprised of three separate functional blocks or elements that are depicted in FIG. 2: a {please spell out what “DECT” stands for} DECT RF receiver 31; a DECT audio interface circuit 48; and a tone/volume control circuit 50. Each of these functional elements is coupled to and controlled by the microcomputer 42.

The DECT audio interface 48 is also coupled to speaker phone circuitry 49 (loud speaker; microphone and associated electronics) in order to provide speaker phone functionality to the remote station 14.

In the cordless phone 10 depicted in FIG. 1, audio signals received from a telephone network by the base station 12 are converted into a digital data stream. The digital data modulates an RF carrier broadcast by a transmitter within the base station 12 and which is received by the remote station 14, so long as the remote station 14 is within range of the signal broadcast by the base station 12.

RF signals received at the DECT receiver 30 from the base station 12 are demodulated into a digital data stream, which is sent to the DECT audio interface 48. The DECT audio interface 48 receives the digital data stream from the receiver 30 and converts the data stream into an analog, i.e., audio, signal. The audio from the DECT audio interface 48 is coupled to a tone/volume control circuit 50 whereby the audio amplitude (volume) and frequency content (tone) characteristics are adjusted according to a volume control 62 input control signal and according to a tone control 64 input control signal received by the tone/volume control circuit 50.

Audio signals from the tone/volume control 50 pass through both a hearing aid induction coil 60 and an earpiece 54 within the handset 22. In the embodiment shown, the induction coil 60 and the earpiece 54 are in series with the coil 60 being placed upstream of the earpiece 54. One alternate embodiment connects the coil 60 and the earpiece 54 in parallel. A second alternate embodiment connects the coil 60 in series with the earpiece but with the coil 60 being connected after or downstream from the earpiece 54. Regardless of how the coil 60 and earpiece 54 are connected, if the radio electronics shown in FIG. 2 are located in the handset platform 24 and not in the handset 22, the signals output from the tone/volume control 50 are coupled to the handset 22 over the cord 25 depicted in FIG. 1.

As set forth above, the DECT receiver 30, the DECT audio interface 48 that processes signals from the DECT receiver 30, and the tone/volume control circuitry 50 are each considered to be part of the “receiver” 30 within the remote station 12, at least for purposes of this disclosure. The volume control 62 and tone control 64 and therefore considered to be input devices to the receiver in the remote station. The signals each of them inputs to the tone/volume control 50 circuitry are therefore considered to be “input” signals to the receiver that is located within the remote station 12.

As for the transmitter in the remote station 12, audio from the microphone 52 within the handset 22 passes through the tone/volume interface 50 without processing and into the DECT audio interface 48 where the microphone 52 signal is converted into a digital data stream. The data stream output from the DECT audio interface 48 is coupled to an input port of the DECT transmitter from where it is transmitted to the base station 12 of the cordless telephone 12.

If the base station's receiver is within the signal range of the remote station 14, the base station receiver 15 demodulates the RF signal to recover the digital data stream. The base station receiver 15 converts the digital data to an analog form, which the base station 12 couples into the telephone network.

Alternate embodiments of the remote station 14 that do not transmit and receive digitally encoded audio need not use a DECT audio interface 50 as shown in FIG. 2. The microphone 52 can be “directly” coupled to an input of the transmitter 32; the earpiece 54 could also be directly coupled to the audio output of the receiver 30.

Still referring to FIG. 2, it can be seen that the signal output from the tone/volume control circuit 50 is output to a hearing-aid compatible (HAC) signal induction coil 60, which is located within the handset 22 and preferably wound around the outside of the earpiece 54 and its voice coil.

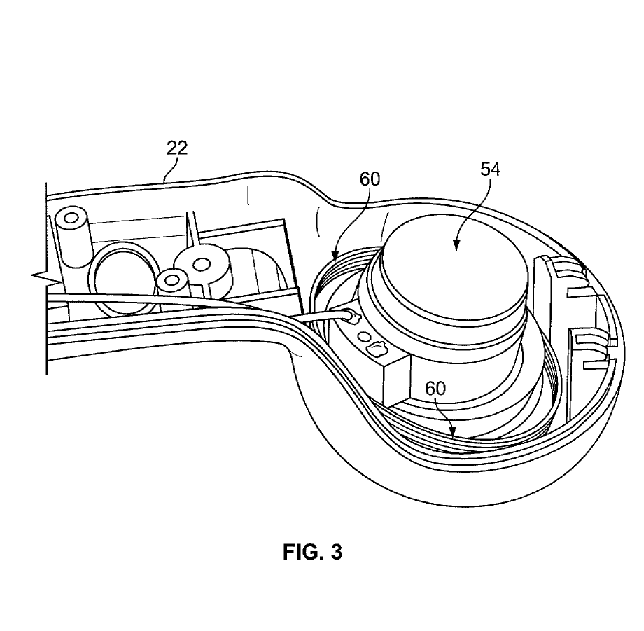

FIG. 3 shows the placement or location of the HAC signal voice coil 60 inside the handset 22 of the remote station 14. As can be seen in FIG. 3, the voice coil 60 is located inside the handset 22 but wound around the exterior of the earpiece 54. Increasing the diameter of the coil 60 so that it can be placed around the outside diameter of the speaker that forms the earpiece 54 increases the coil's “area.” The increased area of the coil 60 increases the area over which a changing B-field (magnetic field) is generated by audio signals from the receiver thereby improving the inductive coupling with the coil 60. Placing the coil 60 around the outside of the speaker that forms the earpiece 54 also makes the handset easier to manufacture.

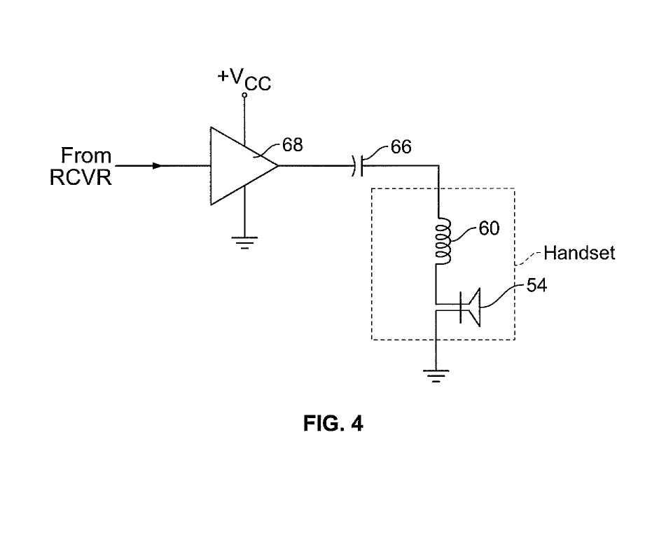

Close inspection of FIG. 3 also shows a D.C. blocking capacitor 66, which is placed between the output of the last output stage of the tone/volume control 50 and the handset 22. FIG. 4 is a schematic diagram showing how the capacitor 66 shown in FIG. 3 is used in the circuitry. The D.C. blocking capacitor 66 reduces D.C. current drain by cutting off a D.C. path to ground through the voice coil 60 and the earpiece 54.

As mentioned above, the remote station 14 of the cordless telephone 10 can have either one or both of the radio receiver 30 and the transmitter 32 located in the handset 22 or in the handset platform 24. Locating the UHF radio circuitry in the handset platform 24, however, provides a much greater separation distance between the UHF radio electronics and sensitive electronic devices that are used in hearing aids. When the cordless telephone 10 is to be used with hearing aids, it is thus preferable that the radio receiver 30 and the radio transmitter of the remote station 14 be located in the handset platform 24. Locating the electronics in the handset platform 24 will also increase its weight making the platform 24 less likely to be inadvertently moved. In some embodiments, a ballast weight is also added to the handset platform 24 to provide even greater weight and stability to the unit.

The circuitry described above is for purposes of illustration only and should not be considered or construed as limiting. The true scope of the invention is set forth in the appurtenant claims.

What is claimed is:

1. A cordless telephone comprising:
a base station having a first radio transmitter and a first radio receiver and further having a connection interface to enable the cordless telephone to be connected to a telephone network;
a remote station comprised of:
a handset platform and a separate handset, said handset platform and said handset being electrically and physically connected to each other through a length of a plurality of wires, said remote station comprising:
a second radio transmitter having an audio input port;
a second radio receiver having an audio output port;
said second radio transmitter and said second radio receiver cooperating with the first radio transmitter and the first radio receiver in the base station to provide a wireless communication link between the base station and the remote station;
said handset further comprised of a microphone and an induction coil, said microphone being electrically connected to the audio input port, said induction coil being connected to said audio output port, said induction coil capable of being spaced away from the second radio transmitter and second radio receiver by the length of said wires, said induction coil being capable of inductively coupling audio signals to a hearing aid proximate to the handset.

2. The cordless telephone of claim 1, wherein at least one of the second radio transmitter and the second radio receiver are located in the handset of the remote station.

3. The cordless telephone of claim 1, wherein said handset is further comprised of an earpiece connected to said audio output port, said earpiece generating audible audio signals to a user of the handset.

4. The cordless telephone of claim 1, wherein the receiver includes a volume control input, which receives a signal to adjust the signal level output from the receiver.

5. The cordless telephone of claim 4, wherein the receiver includes a volume control input, which receives a signal to adjust the signal level output to at least one of the induction coil and the ear piece.

6. The cordless telephone of claim 1, wherein the receiver includes a tone control input, which receives a signal to adjust the frequency of audio signals output to said induction coil from the receiver.

7. The cordless telephone of claim 1, further comprised of a D.C. blocking capacitor connected between an output of the receiver and the induction coil.

8. The cordless telephone of claim 1, wherein the induction coil is inside the handset but wound around the outside of the earpiece.

9. The cordless telephone of claim 1, wherein the remote station is further comprised of a power source for the second transmitter and second receiver, said power source being located in one of the handset and the handset platform.

10. The cordless telephone of claim 1, wherein said remote station is further comprised of a key pad having a plurality of keys, which when activated, generate dual-tone, multi-frequency (DMTF) dialing tones.

11. The cordless telephone of claim 1, wherein said handset platform is further comprised of a cradle for said handset and a switch hook that operates when said handset is in said cradle.

12. The cordless telephone of claim 1, wherein said handset platform is further comprised of a ballast weight.

13. A cordless telephone comprising:
a base station having a first radio transmitter and a first radio receiver and further having an interface to enable the cordless telephone to be connected to a public switched telephone network (PSTN);
a remote station having a second radio transmitter having an audio input port and a second radio receiver having an audio output port, said second radio transmitter and said second radio receiver cooperating with the first radio transmitter and the first radio receiver in the base station to provide a wireless communication link between the base station and the remote station; and
a handset having an earpiece and a microphone, said handset being electrically and physically connected to the remote station through a length of a plurality of wires, said wires connecting the earpiece to said audio output and connecting said microphone to said audio input,
said handset further comprised of a induction coil, operatively coupled to the audio output, said induction coil coupling audio signals from the audio output to a hearing aid, proximate to the earpiece.

14. The cordless telephone of claim 13, wherein the second radio receiver is further comprised of a volume control device, which adjusts the signal level output to at least one of the induction coil and the earpiece.

15. The cordless telephone of claim 13, wherein the second radio receiver is further comprised of a tone control, which adjusts the audio output level from said earpiece.

16. The cordless telephone of claim 13, wherein said remote station is further comprised of a power source for the second transmitter and second receiver.

17. The cordless telephone of claim 13, wherein said remote station is further comprised of a cradle for said handset and a switch that operates when said handset is in said cradle.

18. The cordless telephone of claim 13, wherein said remote station is further comprised of a ballast weight.

19. A cordless telephone comprising:
a remote station comprised of:
a handset platform and a separate handset, said handset platform and said handset being electrically and physically connected to each other through a plurality of wires, said remote station further comprising:
a radio transmitter;
a radio receiver;
said radio transmitter and said radio receiver of the remote station cooperating with a radio transmitter and a radio receiver in a base station in order to provide a wireless communication link between the remote station and a telephone network to which the base station is connected;
said handset further comprised of a microphone and an induction coil, said microphone being electrically coupled to the transmitter within the remote station, the induction coil being coupled to the radio receiver in the remote station, said induction coil being capable of inducing in a hearing aid, signals that represent signals from the radio receiver of the remote station.

20. The cordless telephone of claim 19 wherein at least one of the radio transmitter of the remote station and the radio receiver of the remote station are located in the handset platform.

21. The cordless telephone of claim 19 wherein at least one of the radio transmitter of the remote station and the radio receiver of the remote station are located in the handset.
